(19) United States
(12) Patent Application Publication
(10) Pub. No.: US 2011/0167643 A1
(43) Pub. Date: Jul. 14, 2011

(54) VERSATILE SURVIVAL KNIFE

(76) Inventor: Chien-Rung CHEN, Taipei City (TW)

(21) Appl. No.: 12/686,123

(22) Filed: Jan. 12, 2010

(51) Int. Cl. B26B 1/00; B25G 3/26; B26B 5/00

(52) U.S. Cl. 30/122; 30/344

(57) ABSTRACT

A versatile survival knife includes a handle internally provided with a blade receiving slot; and a blade having a pointed tip and a flat tip separately provided at two opposite ends thereof. The blade is removably connected to the handle by selectively inserting the pointed-tipped end or the flat-tipped end into the blade receiving slot to provide a survival knife with a flat-tipped blade or a pointed-tipped blade, respectively. The blade is further lengthwise provided on a body thereof with a straight row of spaced length-adjusting holes. The blade can be connected at different length-adjusting holes to the handle to adjust a length of the blade that is projected from the handle, so as to provide a long-blade or a short-blade survival knife according to different functions to be performed with the survival knife.

### FIELD OF THE INVENTION

The present invention relates to a survival knife, and more particularly to a versatile survival knife.

### BACKGROUND OF THE INVENTION

A survival knife is a prerequisite item for mountain climbers to survive an emergency in a wild environment or for divers to survive a trouble under water, such as getting tangled with a fishing net, a rope or some other undesirable things.

Please refer to FIG. 1. Conventional survival knives can be generally divided according to a blade length into long-blade survival knives 300, as shown in FIGS. 1A and 1C, and short-blade survival knives 400, as shown in FIGS. 1B and 1D. The long-blade survival knives are usually used in mountain climbing to chop off branches of trees and other obstructions on the road, and can be conveniently used to cut relatively thick things, fruits, etc. However, the long-blade survival knives are not conveniently portable and occupy a large space due to their large size. On the other hand, the short-blade survival knives can be conveniently stored and carried but are not suitable for cutting large and thick things. Further, the conventional survival knives can be divided according to different blade tips into pointed-tipped survival knives 500, as shown in FIGS. 1A and 1B, and flat-tipped survival knives 600, as shown in FIGS. 1C and 1D. The pointed-tipped survival knives 500 are usually used to cut food by piercing its pointed tip into food before cutting the food, while the flat-tipped survival knives 600 are usually used to dig the ground, crush stone, dig out wild vegetables, dig clams and scallops out of rocks, etc.

In brief, the conventional survival knives generally appear in one of four different forms, namely, long-blade, short-blade, pointed-tipped, and flat-tipped survival knives. Generally, consumers would select and purchase one of these four types of survival knives according to their budgets and actual needs. However, one single type of survival knife just could not satisfy different needs of the consumer's in outdoor activities. On the other hand, purchasing all four types of survival knives would cost the consumers a lot of money and it is inconvenient to carry all four types of survival knives at the same time.

Moreover, all the conventional survival knives include a tang 800 that is formed by cutting and blunting two opposite sides of a rear portion of the blade for inserting into a handle 700 of the knife. The tang 800 is provided only for fixedly holding the rear portion of the blade in the handle to form the survival knife without any other function. Thus, material cut off from the blade in forming the tang 800 is wasted and labors and time used for shaping and blunting the same simply increase the cost of the conventional survival knives.

### SUMMARY OF THE INVENTION

To eliminate the disadvantages in using and manufacturing the conventional survival knives, a primary object of the present invention is to provide a versatile survival knife that provides different blade forms and blade lengths for performing different functions with only one blade.

To achieve the above and other objects, the versatile survival knife according to an embodiment of the present invention includes a handle internally provided with a lengthwise extended blade receiving slot; and a blade having a pointed tip and a flat tip separately fromed at two opposite ends thereof. The blade is removably connected to the handle by selectively inserting the pointed-tipped end or the flat-tipped end into the blade receiving slot to expose the opposing flat tip or pointed tip from the handle, so as to provide a survival knife with a flat-tipped blade or a pointed-tipped blade, respectively.

According to the embodiment of the present invention, the blade is further lengthwise provided on a body thereof with a straight row of spaced length-adjusting holes, and the handle is provided at a predetermined position with a locking hole that transversely extends through the handle and the blade receiving slot. The locking hole is provided at one of two opposite ends with a nut embedded in the handle and at the other end with a hand-turnable bolt matching the embedded nut. The blade is connected to the handle by extending the hand-turnable bolt through the locking hole and a selected one of the length-adjusting holes to screw into the nut. Therefore, a length of the blade that is to be projected from the handle can be adjusted by extending the bolt through different length-adjusting holes, so as to provide a long-blade or a short-blade survival knife according to different functions to be performed with the survival knife.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows different types of conventional survival knives and the manner of associating a blade with a handle thereof;

FIG. 2 is an exploded perspective view of a versatile survival knife according to an embodiment of the present invention;

FIG. 3 is a fragmentary assembled sectional view showing a joint of a handle and a blade of the versatile survival knife of FIG. 2;

FIG. 4 shows the blade and the handle of the versatile survival knife of FIG. 2 are assembled into a pointed-tipped long-blade survival knife;

FIG. 5 shows the blade and the handle of the versatile survival knife of FIG. 2 are assembled into a flat-tipped long-blade survival knife;

FIG. 6 shows the blade and the handle of the versatile survival knife of FIG. 2 are assembled into a pointed-tipped short-blade survival knife; and

FIG. 7 shows the blade and the handle of the versatile survival knife of FIG. 2 are assembled into a flat-tipped short-blade survival knife.

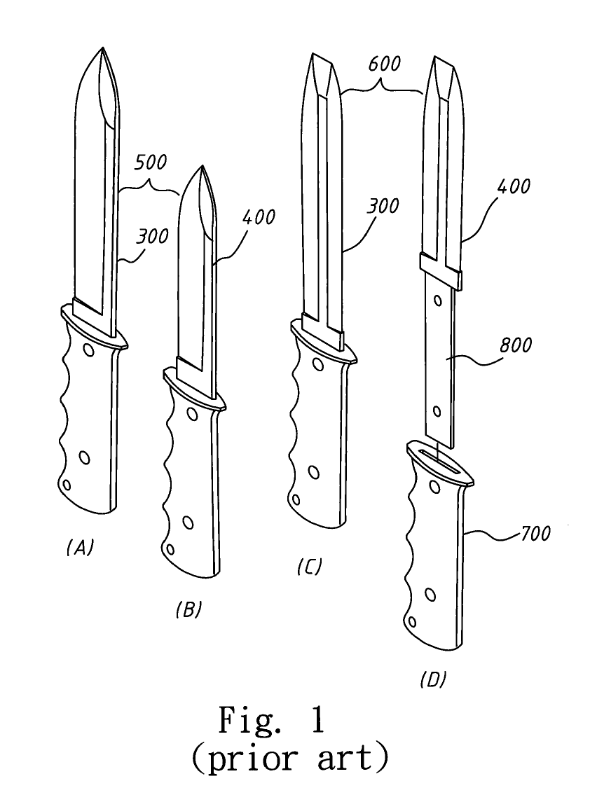

### DETAILED DESCRIPTION OF THE PREFERRED EMBODIMENTS

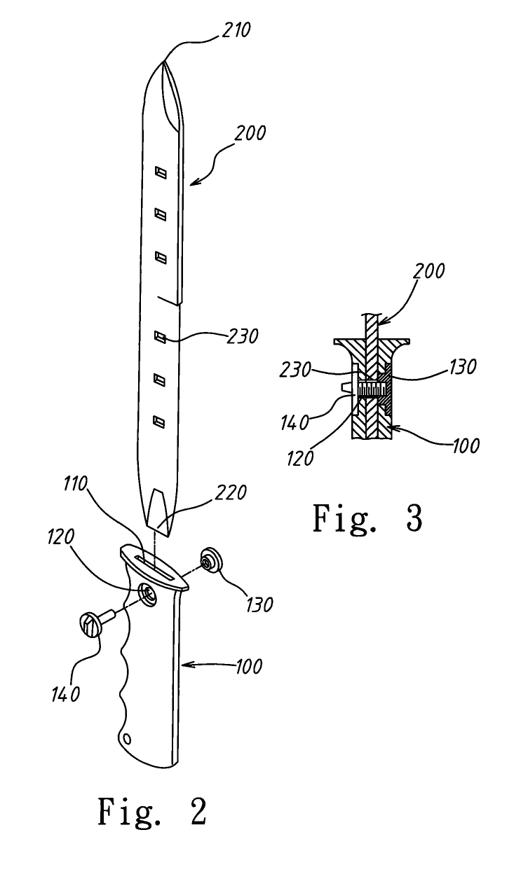

Please refer to FIGS. 2 and 3 that are exploded perspective view and fragmentary assembled sectional view, respectively, of a versatile survival knife according to an embodiment of the present invention. As shown, the versatile survival knife of the present invention includes a handle 100 and a blade 200.

The handle 100 is internally provided a lengthwise extended blade receiving slot 110, and is provided at a predetermined position with a locking hole 120 that transversely extend through the handle 100 and the blade receiving slot 110. A nut 130 is embedded in the handle 2 to locate at one of two opposite ends of the locking hole 120. A hand-turnable bolt 140 matching the embedded nut 130 can be screwed into the locking hole 120 from the other end thereof to engage with the embedded nut 130. The blade 200 is provided at two lengthwise opposite ends with a pointed tip 210 and a flat tip 220, and is lengthwise provided on a body thereof with a straight row of spaced length-adjusting holes 230. The blade 200 is removably received in the blade receiving slot 110 of the handle 100 with either the pointed tip 210 or the flat tip 220 exposed from the handle 100. When the blade 200 is received in the blade receiving slot 110, the hand-turnable bolt 140 can be extended through the locking hole 120 on the handle 100 and a desired one of the length-adjusting holes 230 on the blade 200 to screw into the embedded nut 130, so as to firmly connect the blade 200 to the handle 100.

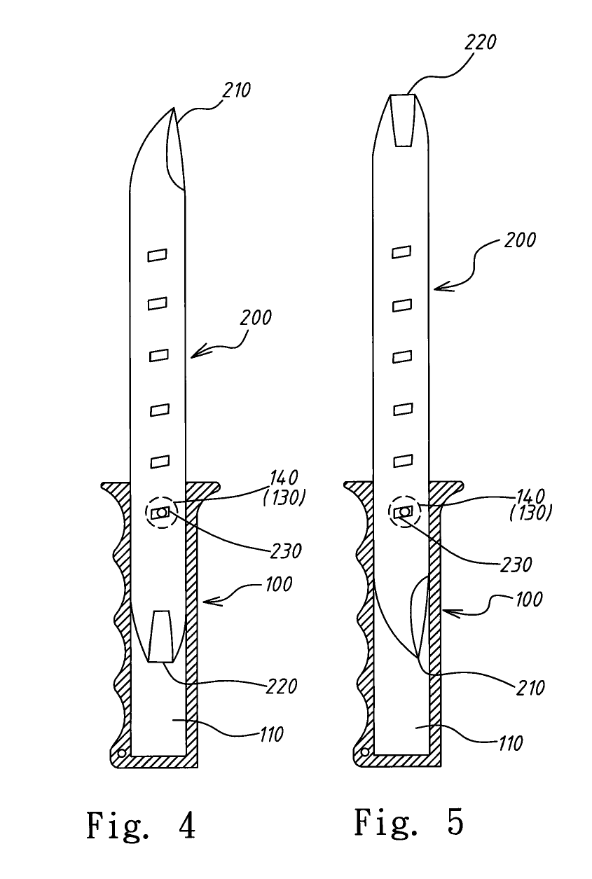

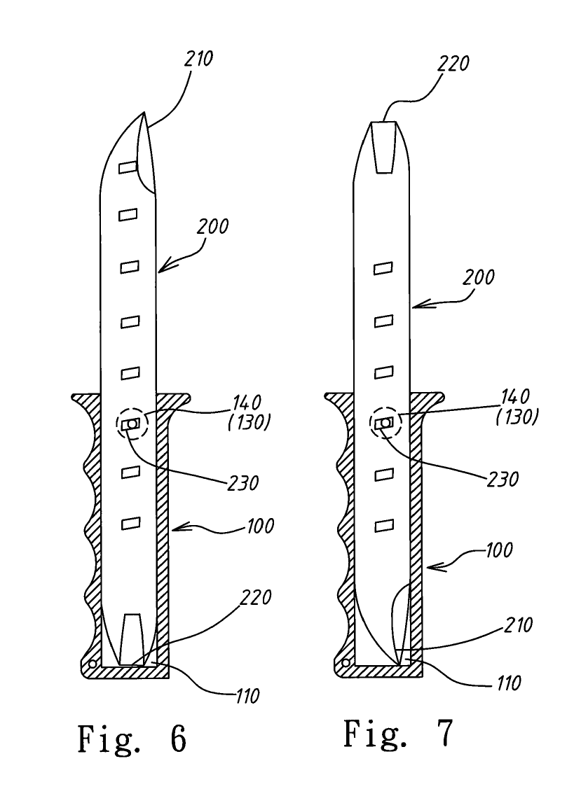

FIGS. 4 through 7 shows the blade 200 and the handle 100 of the versatile survival knife according to the embodiment of the present invention illustrated in FIG. 2 are assembled to each other in different manners. As shown in FIGS. 4 and 6, the blade 200 is connected to the handle 100 with the end having the flat tip 220 received in the blade receiving slot 110, and then, the hand-turnable bolt 140 is extended through the locking hole 120 and a selected one of the length-adjusting holes 230 to screw into the embedded nut 130, so that the pointed tip 210 of the blade 200 is exposed from the handle 100 to provide a pointed-tipped survival knife. Alternatively, as shown in FIGS. 5 and 7, the blade 200 is connected to the handle 100 with the end having the pointed tip 210 received in the blade receiving slot 110, and then, the hand-turnable bolt 140 is extended through the locking hole 120 and a selected one of the length-adjusting holes 230 to screw into the embedded nut 130, so that the flat tip 220 of the blade 200 is exposed from the handle 100 to provide a flat-tipped survival knife. That is, the blade 200 of the versatile survival knife of the present invention can be differently connected to the handle 100 to thereby provide a pointed tip 210 or a flat tip 220 on the survival knife according to actual need in use.

Furthermore, no matter the versatile survival knife of the present invention is assembled to provide a pointed tip 210 or a flat tip 220, the length of the blade 200 that is projected from the handle 100 can be adjusted by extending the hand-adjustable bolt 140 through a selected one of the row of length-adjusting holes 230 on the blade 200, so that the blade 200 is connectable at different length-adjusting holes 230 to the handle 100. In this manner, a long-blade survival knife with a pointed tip 210 or a flat tip 220 as shown in FIGS. 4 and 5, respectively, or a short-blade survival knife with a pointed tip 210 or a flat tip 220 as shown in FIGS. 6 and 7, respectively, can be obtained. That is, the blade 200 of the versatile survival knife of the present invention can be differently connected to the handle 100 to thereby provide a long blade or a short blade according to actual need in use.

Therefore, according to the versatile survival knife of the present invention, total four different blade types can be provided for different functions while there is only one blade. Namely, a pointed-tipped long-blade survival knife as shown in FIG. 4, a flat-tipped long-blade survival knife as shown in FIG. 5, a pointed-tipped short-blade survival knife as shown in FIG. 6, and a flat-tipped short-blade survival knife as shown in FIG. 7 can be provided to perform different functions. And, the portion of the blade that is otherwise used as a tang 800 as in the conventional survival knife can be fully utilized without being cut to cause unnecessary waste of material and increased fabricating cost.

Further, the straight row of length-adjusting holes 230 on the blade 200 are through holes, which provide an anti-slip effect for a user to safely and securely hold the blade 200 with fingers when trying to remove and replace the blade 200 from and into the handle 100 to convert the survival knife from one form to another without the risk of a slipped blade 200.

In brief, the present invention provides a versatile survival knife by forming at two opposite ends of the blade with a pointed tip and a flat tip and on the body of the blade with a straight row of spaced length-adjusting holes. With the pointed tip and the flat tip provided at two opposite ends of the blade, the survival knife can be converted to have a pointed-tipped blade or a flat-tiped blade by inserting the other end into the blade receiving slot on the handle. And, with the row of spaced length-adjusting holes, the length of the blade to be projected from the handle of the survival knife can be adjusted to provide a long-blade or a short-blade survival knife. Since different forms are available from only one single blade, the survival knife of the present invention can be used to perform different functions in outdoor activities to thereby provide excellent applicability.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A versatile survival knife, which can be converted among different blade forms to perform different functions, comprising:
a handle being internally provided with a lengthwise extended blade receiving slot; and
a blade being lengthwise provided at two opposite ends with a pointed tip and a flat tip, and the blade being removably connected to the handle by selectively inserting the pointed tip or the flat tip into the blade receiving slot.

2. The versatile survival knife as claimed in claim 1, wherein the blade is lengthwise provided on a body thereof with a straight row of spaced length-adjusting holes, and the handle is provided at a predetermined position with a locking hole that transversely extends through the handle and the blade receiving slot; the locking hole being provided at one of two opposite ends with a nut embedded in the handle and at the other end with a hand-turnable bolt matching the embedded nut; and the blade being connected to the handle by extending the hand-turnable bolt through the locking hole and a selected one of the length-adjusting holes to screw into the nut.
